(19) United States
(12) Patent Application Publication
(10) Pub. No.: US 2024/0307873 A1
(43) Pub. Date: Sep. 19, 2024

(54) Microfluidic Device and Method for Operating a Microfluidic Device

(71) Applicant: Robert Bosch GmbH, Stuttgart (DE)

(72) Inventor: Daniel Sebastian Podbiel, Rutesheim (DE)

(21) Appl. No.: 18/576,245

(22) PCT Filed: Jul. 1, 2022
(86) PCT No.: PCT/EP2022/068241

§ 371 Date: Jan. 3, 2024

(30) Foreign Application Priority Data
Jul. 5, 2021 (DE) 10 2021 207 014.0

(51) Int. Cl. B01L 3/00

(52) U.S. Cl. CPC B01L 3/502738; B01L 2300/161; B01L 2400/0487; B01L 2400/0638

(57) ABSTRACT

A microfluidic device includes a feed channel for guiding a liquid, the feed channel leading into a channel interface. The device also includes a first discharge channel for additional guiding of the liquid, the discharge channel being fluidically connected to the feed channel by way of the channel interface. The device further includes a valve pre-channel for additional guiding of the liquid, the discharge channel being fluidically connected to the feed channel by way of the channel interface. In addition, the device includes a valve which is disposed between the valve pre-channel and a second discharge channel. When the device is in the ready-for-operation state, the valve pre-channel includes a gas volume for shielding the valve from the liquid.

### THE PRIOR ART

The invention proceeds from a microfluidic device and a method for operating a microfluidic device belonging to the class of patent specified in the independent claim.

Microfluidic analysis systems, which are referred to as lab-on-chips or LoCs, enable an automated, reliable, fast, compact, and cost-effective processing of patient samples for medical diagnostics. By combining a variety of operations for controlled manipulation of fluids, complex molecular diagnostic test procedures can be performed on a lab-on-chip cartridge.

### DISCLOSURE OF THE INVENTION

Against this background, the approach presented herein provides a microfluidic device and a method for operating a microfluidic device according to the independent claims. Advantageous embodiments of and improvements to the device specified in the independent claim are made possible by the measures presented in the dependent claims.

The microfluidic device presented herein is advantageously designed to prevent seal infiltration of microfluidic valves. In addition, tolerances due to the manufacturing process or tolerances that occur during the intended use of the device can be made possible without these having a critical effect on the microfluidic functionality of the device. In a particularly advantageous way, microfluidic transport of sample material dissolved in liquid is possible in the microfluidic device, whereby the formation of a liquid film in the area of the sealing surface of a microfluidic valve can be prevented. The device presented herein can therefore be used in a particularly advantageous way to enable sequential processes, i.e., microfluidic processes in which different liquid solutions are pumped through areas of a microfluidic network, in a microfluidic system without undesired mixing of different liquid solutions or, in general, loss of a volume of a liquid solution due to infiltration of a seal on a microfluidic valve in relation to a specified process step.

A microfluidic device is presented, the device having a feed channel for guiding a liquid, the feed channel leading into a channel interface. The device further comprises a first discharge channel for additional guiding the liquid, the first discharge channel being fluidically connected to the feed channel via the channel interface, a valve pre-channel for additional guiding the liquid, the valve pre-channel being fluidically connected to the feed channel via the channel interface, and a valve disposed between the valve pre-channel and a second discharge channel. When the device is in a ready-for-operation state, the valve pre-channel comprises a volume of gas to shield the valve from the liquid. Preferably, the microfluidic device therefore comprises a liquid, which can be located in particular in the valve pre-channel, with a gas volume being located between the liquid and the valve, in particular when the microfluidic device is used as intended. The expression “ready-for-operation state” is therefore preferably understood to mean that at least part of the liquid is in the feed channel and/or in the channel interface and/or in the valve pre-channel and a gas volume is in the valve pre-channel. The gas volume can be a quantity of a gas mixture, e.g. air, or a single gas, e.g. nitrogen.

The valve pre-channel preferably has a predetermined maximum width depending on the capillary length and/or the surface tension of the liquid used, in particular a maximum lateral expansion of a cross-sectional area of the valve pre-channel, so that the surface tension advantageously causes a stabilization of the geometry of the phase interface between the gas volume and the liquid at least in a partial area of the valve pre-channel adjacent to the channel interface. The maximum width can in this case preferably be less than or equal to 1.5 times the capillary length. Preferably, the maximum width is smaller than the capillary length of the liquid.

The microfluidic device can, e.g., be a microfluidic analysis cartridge that can, e.g., be used to analyze patient samples. Additionally or alternatively, the microfluidic device can, e.g., be used to perform further microfluidic operations and applications, such as the extraction of components from a sample substance or the cultivation of cells in a microfluidic system. For this purpose, the device can have a number of different microfluidic channels, valves and chambers, which can, e.g., be designed to guide a liquid or to perform various reactions. In particular, the channel interface can be a connection of several channels so that a fluid can pass from one of these channels into another of these channels. Preferably, the channel interface connects three channels, and four or more than four channels in other embodiments. The channel interface can be an intersection of several channels, e.g. a T-shaped intersection of three channels. In special embodiments, the channel interface can also have one or more additional valves for temporarily blocking fluids. The liquid can, e.g., contain sample material or a sample substance that can be processed within the microfluidic device. The sample material can, e.g., be an aqueous solution, obtained from, e.g., a biological substance, e.g. of human origin, e.g. a body fluid, a swab, a secretion, sputum, a tissue sample, or a device with attached sample material. The sample liquid can, e.g., contain species of medical, clinical, diagnostic or therapeutic relevance such as bacteria, viruses, cells, circulating tumor cells, cell-free DNA, proteins or other biomarkers or, in particular, components from the aforementioned objects. For example, the sample liquid can be what is referred to as a master mix or components thereof, e.g. for performing at least one amplification reaction, e.g. for DNA detection at the molecular level, such as an isothermal amplification reaction or a polymerase chain reaction.

To process the sample material, the liquid used in the device can, e.g., be fed through the feed channel with the valve closed. In this case, particularly when using membrane-based valves, the liquid should be prevented from penetrating the valve in order to, e.g., to prevent the seal from being infiltrated in the valve area or to prevent the valve from being wetted with the liquid, e.g. by capillary forces. Accordingly, a valve pre-channel is advantageously disposed between the feed channel and the valve in the device presented herein. The valve pre-channel can also be referred to as a capacitive capillary valve pre-channel (CCVV channel) or capacitive capillary valve pre-channel (CCVP channel). This is a structural functional element of the microfluidic system which can be used for improved guidance of a liquid in the microfluidic system and in particular to prevent possible seal infiltration of the valve. The device is based in particular on the findings that no infiltration of the valve caused by capillary forces can occur on a valve whose membrane has not come into contact with liquid, and that short-term pressure fluctuations in the system can be compensated for by the capacitive effect of a gas volume enclosed in a valve pre-channel before a valve, thereby preventing leakage of the valve behind it. In this context, the particularly advantageous functionality of the device presented herein results not only from the capacitive effect of a gas volume present in the valve pre-channel, but also from the stabilization of the geometry of the phase boundary surface present in the valve pre-channel based on capillary forces, which can have the effect that liquid that has briefly entered the valve pre-channel due to pressure fluctuations can be completely removed from the valve pre-channel again by the counterpressure that builds up in the enclosed gas volume.

According to one embodiment, the valve can be designed to separate the valve pre-channel from the second discharge channel. For example, the valve can be closed and thereby separate the second discharge channel from the valve pre-channel when the liquid is to be fed from the feed channel into the first discharge channel for processing. In this advantageous way, both the valve and the valve pre-channel can, e.g., act as a separating element of a microfluidic functional unit. In this context, a functional unit can be understood as an arrangement of microfluidic elements, which in their entirety provide at least one, generally also several, functions or functionalities that can be used to perform a microfluidic process. For example, in the course of the microfluidic process, the functional units can be used sequentially and successively. It can in this case be desirable that no liquid transport occurs in a functional unit before it is used as planned in the course of the microfluidic process. Otherwise, this could adversely affect the functionality of the functional unit. In this context, a valve pre-channel with a valve behind it therefore serves as an access channel, or gate, for a controlled exchange of liquids with a microfluidic functional unit. This functionality can advantageously provide reliable microfluidic isolation of individual areas of the microfluidic network of the device until it is used, and undesired microfluidic cross-talk between the various process steps of a microfluidic sequence can be prevented.

According to a further embodiment, the valve pre-channel can be disposed at essentially right angles to the feed channel and additionally or alternatively to the first discharge channel. For example, the valve pre-channel with the valve behind it can be connected to another channel, such as the feed channel and the first discharge channel, of the microfluidic network in an almost T-shape. A T-shaped connection of the valve pre-channel to a channel of the microfluidic network can, on the one hand, advantageously achieve pinning of a phase interface before liquid enters the valve pre-channel. On the other hand, the occurrence of inertial forces exerted on the valve by the liquid can be prevented by a virtually right-angled connection of a valve pre-channel with a valve behind it to a liquid feed channel. In other words, a necessary change of direction or deflection of a liquid flow can, e.g., be achieved by a suitable channel guide in which the walls of the channel absorb the inertial forces or the momentum transfer that can be transmitted by the liquid when a liquid flow is deflected.

According to a further embodiment, the valve pre-channel can be hydrophobic and the feed channel and additionally or alternatively the first discharge channel can be hydrophilic. For example, both the feed channel and the first discharge channel can be hydrophilic. Advantageously, this makes it easier to guide the liquid in these channels and at the same time prevents the liquid from penetrating the hydrophobic valve pre-channel.

According to a further embodiment, the device can be designed as a pressure-based system. For example, the pressure-based system can enable controlled microfluidic transport of liquids in the device by applying at least two pressure levels. In this case, the device can, e.g., be based on the use of a flexible membrane, which can be integrated into the device and which can be used to create the liquid transport in the cartridge. The latter can, e.g., be achieved by a controlled pressure-based, i.e. pneumatically controlled, deflection of the membrane into recesses provided for this purpose in the device in order to effect a targeted displacement of liquids. The integration of a flexible membrane into the device combines several advantages: As just specified, a targeted deflection of the membrane into defined recesses provided for this purpose in the device can then be utilized to displace and process defined volumes of liquid. Furthermore, by using a flexible membrane, the liquids can be almost completely enclosed in the device during processing and only vent openings are required. This can advantageously prevent contamination of the environment by the sample or vice versa. In addition, such microfluidic lab-on-chip cartridges can be manufactured cost-effectively from polymers using series production methods such as injection molding or laser transmission welding.

According to a further embodiment, the valve can be membrane-based. For example, membrane-based valves can be used to control the transport of liquids within a pressure-based microfluidic device. The flow through a microfluidic channel can be controlled by deflecting the flexible membrane onto a valve web. This can require suitable surface properties of the materials, such as a defined surface roughness, in order to achieve the best possible seal using such membrane-based microfluidic valves. Advantageously, membrane-based valves can be manufactured cost-effectively and used for directing liquids within the device.

According to a further embodiment, the valve can comprise an actuation channel for the controlled deflection of a membrane into a valve recess. For example, the switching of the microfluidic valve can be achieved by a pressure-based deflection of an elastic membrane into the valve recess, whereby the pressure can be applied to the membrane via a pneumatic actuation channel. This has the advantage that the valve can be precisely controlled.

According to a further embodiment, the valve pre-channel can have a length of 0.5 mm to 10 mm and additionally or alternatively a cross-section of 100×100 μm² to 3×3 mm² and additionally or alternatively a volume of 100 nL to 5 μL. Advantageously, capillary forces occurring within the valve pre-channel can be used to effect capillary stabilization of the geometry of the phase interface when a liquid enters the valve pre-channel. The width or a dimension of the cross-section of the valve pre-channel is in particular smaller than the capillary length of the liquid used. In a further embodiment, the width of the valve pre-channel is 0.1 times to 1.5 times the capillary length of the liquid, preferably 0.2 to 1.0 times the capillary length of the liquid and in particular preferably 0.2 to 0.5 times the capillary length of the liquid, in order to achieve reliable stabilization of the geometry of the phase interface between the liquid and the gas volume on the one hand and to achieve simple manufacturability of the device and low fluidic resistance when pumping liquid through the valve pre-channel on the other.

According to a further embodiment, the device can comprise a further valve pre-channel, which can be fluidically connected via a further channel interface to a further feed channel and additionally or alternatively to a further first discharge channel, in which case the further valve pre-channel can be disposed between a further valve and the further channel interface, in which case the further valve pre-channel can comprise a gas volume for shielding the further valve from the liquid in the ready-for-operation state of the device. For example, the device can comprise a plurality of functional units for processing sample material, each unit being separable from another unit by a valve and a valve pre-channel. Accordingly, a further valve pre-channel can, e.g., be disposed at a point in a microfluidic network that is comparable to the valve pre-channel. This has the advantage that different processes with, e.g., different liquids can, e.g., be performed sequentially within the device, whereby a negative influence of the processes on each other can be avoided.

A method for operating a variant of the microfluidic device presented hereinabove is also presented, the method comprising a step of closing the valve and a step of introducing a liquid into the feed channel and preferably into the valve pre-channel, the liquid being held by the valve due to the volume of gas. As explained hereinabove, the gas volume advantageously prevents the liquid from coming into contact with the valve. In particular, if there is not yet a volume of gas in the valve pre-channel, then, according to a particular embodiment of the method, the gas volume can be introduced into the valve pre-channel before the liquid is introduced.

According to one embodiment, a pressure, in particular an overpressure, can be applied to a membrane of the valve in the closing step in order to close the valve. For example, the valve can be controlled by an actuation channel, in which case the valve can be closed by applying excess pressure to the actuation channel. Advantageously, a controlled deflection of the membrane, so a controlled closing of the valve can be achieved.

According to a further embodiment, a pressure, in particular an overpressure, can be applied to a storage chamber storing the liquid during the introduction step in order to introduce the liquid into the feed channel. For example, the liquid can be stored in the storage chamber until it is needed for the transportation of sample material. Advantageously, the liquid can therefore be introduced into the microfluidic channel system at any time and as required. Additionally or alternatively, the liquid can be drawn from the storage chamber by creating a vacuum in the microfluidic channel system and introduced into the microfluidic channel system.

According to a further embodiment, the method can comprise a step of discharging the liquid via the first discharge channel, whereby the gas volume can be compressed during the step of introduction and expanded during the step of discharge. For example, the pressure that can be transmitted by the inflowing liquid can be increased by means of a pumping process in the microfluidic device. As a result, liquid can enter the valve pre-channel. The air volume in the valve pre-channel can thereby be compressed, so a back pressure might build up. Preferably, when the liquid enters the valve pre-channel, an interface, in particular having a shape stabilized by capillary forces, forms between the gas volume and the liquid in the valve pre-channel. After a short time, the liquid can continue to move through the microfluidic network along the open path, i.e. along the first discharge channel, and the hydraulic pressure can drop again. Due to the drop in pressure exerted by the inflowing liquid, the capacitive effect of the gas volume in the valve pre-channel can then unfold: The previously existing back pressure, which was built up by the gas volume, can also relax, so the liquid that previously entered the valve pre-channel can be completely pressed out of it again. Preferably, the liquid that has penetrated into the valve pre-channel is in this case completely displaced from the valve pre-channel, supported by the interface between the liquid and the gas volume, which is preferably formed in the valve pre-channel and preferably stabilized by the capillary forces. In other words, the valve pre-channel can be used in a particularly advantageous way for a large number of such pumping processes without any undesirable infiltration of the seal of the valve located behind it.

According to a further embodiment, the method can comprise a step of opening the valve. For example, the valve can be opened if, e.g., a process is to be performed in the unit of the microfluidic system previously separated by the valve. The pneumatic actuation channel can, e.g., be disposed on the opposite side of the membrane in relation to the fluidics. It can therefore be necessary to apply pressure, in particular overpressure, to press the valve membrane onto the valve web and close the valve. Advantageously, the liquid can then be passed through the valve pre-channel and the second discharge channel in order to be processed in the previously separated unit of the microfluidic system.

This method can, e.g., be implemented as software or hardware, or in a mixed form of software and hardware, e.g. in a control unit.

Exemplary embodiments of the approach presented herein are shown in the drawings and explained in greater detail in the subsequent description. Shown are:

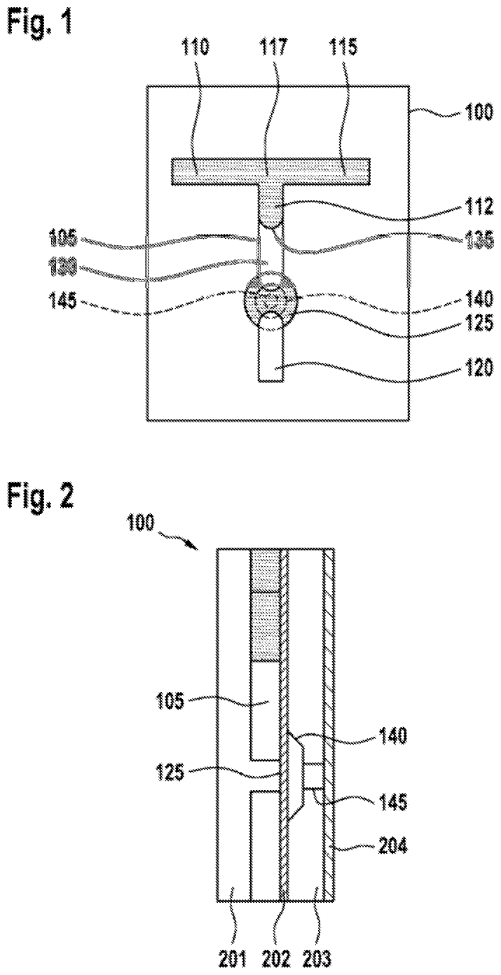

FIG. 1 a schematic top view of an exemplary embodiment of a microfluidic device comprising a valve pre-channel;

FIG. 2 a schematic side view of an exemplary embodiment of a microfluidic device comprising a valve pre-channel;

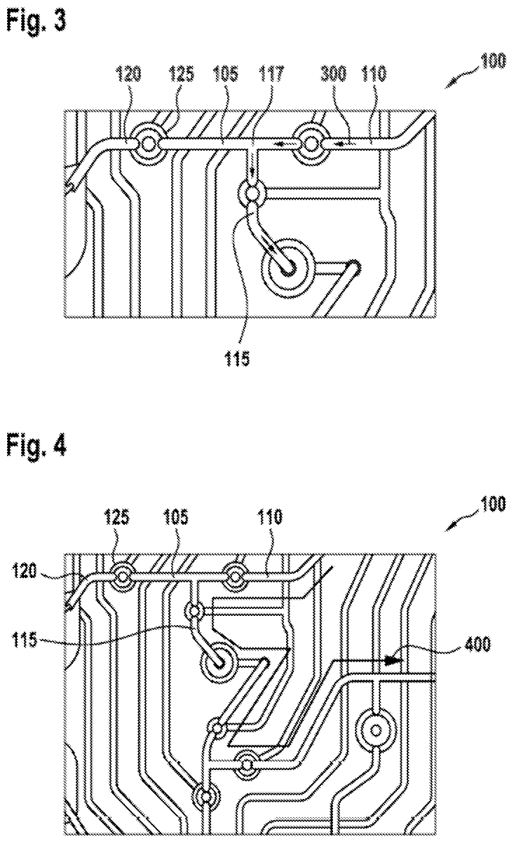

FIG. 3 a schematic top view of an exemplary embodiment of a microfluidic device comprising a valve pre-channel;

FIG. 4 a schematic top view of an exemplary embodiment of a microfluidic device comprising a valve pre-channel;

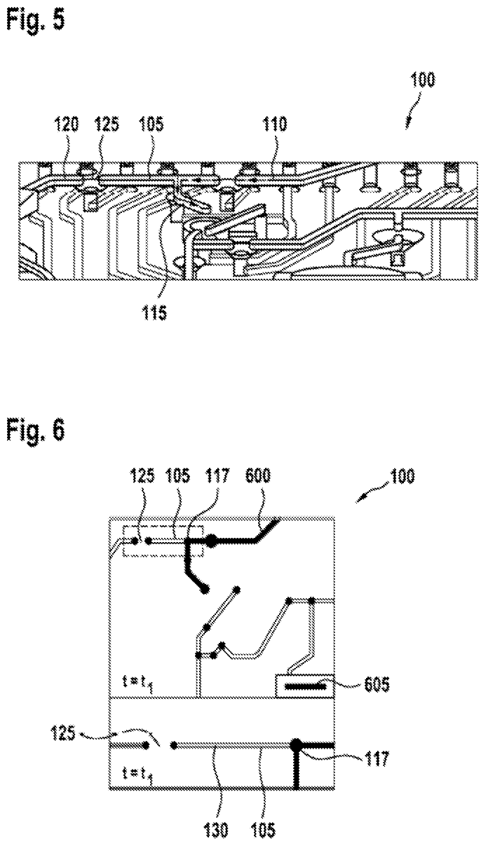

FIG. 5 a perspective side view of an exemplary embodiment of a microfluidic device comprising a valve pre-channel;

FIG. 6 a top view of an exemplary embodiment of a microfluidic device with a valve pre-channel in the operating state;

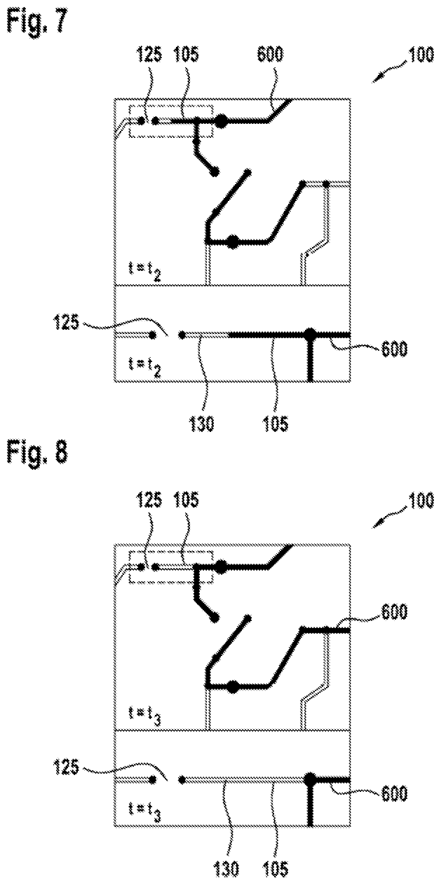

FIG. 7 a top view of an exemplary embodiment of a microfluidic device with a valve pre-channel in the operating state;

FIG. 8 a top view of an exemplary embodiment of a microfluidic device with a valve pre-channel in the operating state;

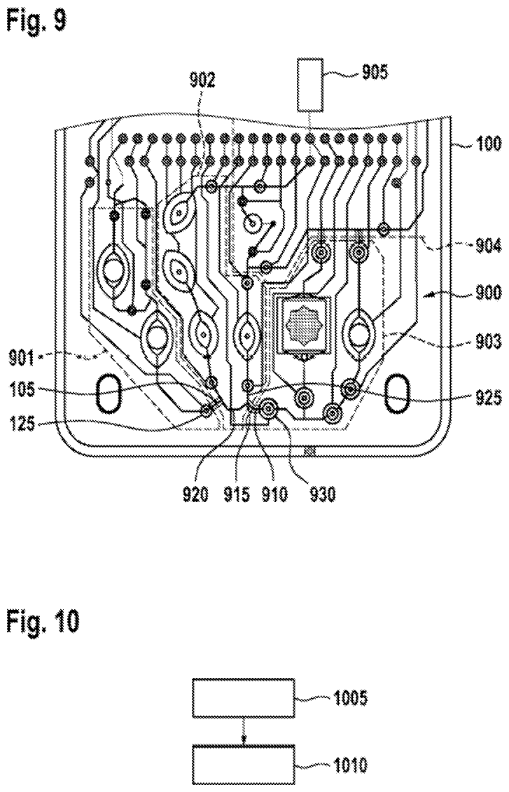

FIG. 9 a schematic top view of an exemplary embodiment of a microfluidic device;

FIG. 10 a flow chart of a method for operating a microfluidic device according to an exemplary embodiment;

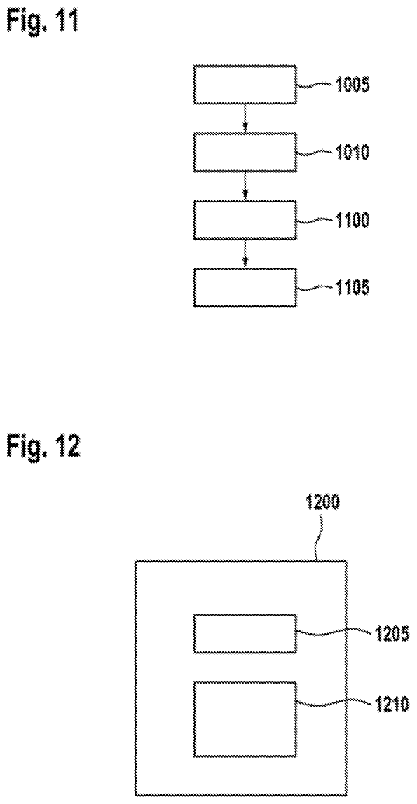

FIG. 11 a flowchart of a method for operating a microfluidic device according to an exemplary embodiment; and

FIG. 12 a schematic representation of an exemplary embodiment of an analyzer for holding a microfluidic device.

In the following description of advantageous exemplary embodiments of the present invention, identical or similar reference characters are used for the elements shown in the various drawings and acting similarly, in which case a repeated description of these elements has been omitted.

FIG. 1 shows a schematic top view of an exemplary embodiment of a microfluidic device 100 comprising a valve pre-channel 105. The device 100 shown in this case is characterized by a feed channel 110 for guiding the liquid 112 and a first discharge channel 115 for further guiding the liquid 112, the feed channel 110, the first discharge channel 115, and the valve pre-channel 105 being fluidically connected to each other by a channel interface 117. By way of example only, the valve pre-channel 105 is in this case disposed at a right angle to the feed channel 110 and the first discharge channel 115. In addition, the device 100 comprises a second discharge channel 120, which in this exemplary embodiment can be separated from the valve pre-channel 105 via (by way of example only) a membrane-based microfluidic valve 125. In other words, the capacitive capillary valve pre-channel 105 is disposed between the valve 125 and the transition point between the feed channel 110 and the first discharge channel 115.

By way of example only, the microfluidic channels, e.g. the valve pre-channel 105, the feed channel 110, and the first and second discharge channels 115, 120 have a cross-section of 600×400 μm² in this exemplary embodiment. In another exemplary embodiment, the channels can have a cross-section of 100×100 μm² to 3×3 mm², preferably 300×300 μm² to 1×1 mm². In this case, the liquid 112 is, e.g., water and the capillary length lₖₐₚ=√(γ/(ρg)) at 20° C.=2.7 mm with a surface tension or surface energy of γ=0.073 J/m², a density of ρ=10³ kg/m³ and an acceleration due to gravity of g=9.81 m/s². The capillary length is defined by the square root of the quotient of the surface energy and the product of the density and the acceleration due to gravity. Therefore, the ratio of a maximum width of the valve pre-channel 105 and the capillary length of the liquid 112 is:

$$0.6 mm / 2.7 mm = 2 / 9 = 0.22 .$$

The use of a liquid 122 such as an aqueous solution with an added detergent or an increase in temperature can reduce the surface tension of the liquid and thus reduce the capillary length. In order to achieve reliable stabilization of the phase interface in the valve pre-channel 105, the capillary length should be greater than the maximum width of the valve pre-channel, i.e., √(γ/(ρg))>0.6 mm. Consequently, the surface tension at a density of =10³ kg/m³ and an acceleration due to gravity of =9.81 m/s² should be at least 0.0036 J/m², i.e., ≥0.0036 J/m².

In this exemplary embodiment, the valve pre-channel 105 is, merely by way of example, is in this case designed to have a length of 4 mm and a volume of only 1 μL. In another exemplary embodiment, the valve pre-channel can have a length of 0.5 mm to 10 mm, preferably 1 mm to 5 mm, and a volume of 100 nL to 5 μL, preferably 500 nL to 2.5 μL. In one exemplary embodiment, the valve 125 is, merely by way of example, in this case designed to have an effective displacement volume of only 125 nL. In another exemplary embodiment, the valve 125 can have a displacement volume of 80 nL to 1 μL, preferably 100 nL to 300 nL.

In the drawing shown in this case, the device 100 is shown ready for operation and the valve pre-channel 105 comprises a gas volume 130, which can also be described as a gaseous medium. By way of example only, the gas volume 130 in this exemplary embodiment is air, which acts as a volume capacity with respect to pressure fluctuations.

Furthermore, in the embodiment shown in this case, a liquid 112 is directed into the feed channel 110 and the first discharge channel 115, whereby the liquid 112 has partially entered the valve pre-channel 105 adjacent to the channel interface 117. In this exemplary embodiment, the liquid 112 is an aqueous solution for transporting sample material. In other exemplary embodiments, aqueous solutions, e.g. buffer solutions, e.g. with components of a sample substance, mineral oils, silicone oils, or fluorinated hydrocarbons can be processed in the device. In this exemplary embodiment, the liquid 112 in this case features a capillary phase interface 135 with the gas volume 130.

The membrane-based microfluidic valve 125 is closed. In other words, in this exemplary embodiment, the membrane of the microfluidic valve 125 is pressed onto a valve web by a pneumatically applied pressure in order to achieve a seal. The switching of the microfluidic valve 125 is thus achieved in this exemplary embodiment by a pressure-based deflection of an elastic membrane into a valve recess 140, in which case the pressure can, by way of example only, be applied to the membrane only via a pneumatic actuation channel 145.

When the valve 125 is closed, and the liquid 112 has partially entered the valve pre-channel 105, the gas volume 130 fills a portion of the valve pre-channel 105 adjacent to the valve 125. In this case, the gas volume 130 completely fills the valve pre-channel 105, at least in portions, i.e. over the entire cross-section of the valve pre-channel 105. In this way, the valve 125 is reliably shielded from the liquid 112. Only when the valve 125 is opened can the gas volume 130 escape via the valve 125, so that the liquid 112 can penetrate to the valve 125 and pass through the valve 125 until the valve 125 is closed again.

FIG. 2 shows a schematic side view of an exemplary embodiment of a microfluidic device 100 comprising a valve pre-channel 105. The device 100 shown in this case and the valve pre-channel 105 correspond to or are similar to the device and the valve pre-channel described in the preceding drawing. In this exemplary embodiment, the device 100 is made up of a total of four polymer layers. Two layers 201 and 203 are merely examples of two rigid injection-molded polymer parts containing fluidic and pneumatic microchannels. The layer disposed in between is achieved by means of an elastic membrane 202, to which a pressure can be applied locally by means of pneumatic actuation channels in order to deflect it into recesses and thus generate and/or control a liquid transport within the device 100. Accordingly, in this exemplary embodiment, a controlled deflection of the layer designed as a membrane 202 into the valve recess 140 can be achieved by the pneumatic actuation channel 145 disposed on the valve 125. The fourth layer 204 is, by way of example only, implemented as a polymer film, which is used to to seal the microchannels present in the layer 203. In one advantageous embodiment, the individual layers 201, 203, 204 and the membrane 202 are alternately optically transparent and absorbent in order to enable simple and cost-effective provision of the layers by means of laser transmission welding.

The shape of the valve 125 shown in FIG. 2 is merely selected as an example. The valve 125 can also be realized in another form suitable for microfluidics.

FIG. 3 and FIG. 4 each show a schematic top view of an exemplary embodiment of a microfluidic device 100 comprising a valve pre-channel 105. The device 100 shown in this case and the valve pre-channel 105 correspond to or are similar to the device and the valve pre-channel described in the preceding drawings. In detail, FIG. 3 shows a section of a top view representation with the flow direction 300 drawn in and FIG. 4 shows a larger section of a top view representation with a liquid path 400 drawn in compared to FIG. 3.

As shown in FIG. 3 by the arrows indicating the flow direction 300, a liquid as described in the preceding FIG. 1 can be introduced via a feed channel 110 and discharged via a first discharge channel 115. At the channel interface 117, or the crossing point of the feed channel 110 and the first discharge channel 115, the valve pre-channel 105 is disposed in a straight extension of the feed channel 110 so that the feed channel 110, the first discharge channel 115, and the valve pre-channel 105 form a T-shaped, right-angled connection in this exemplary embodiment. A microfluidic valve 125 which is, by way of example only, membrane-based, is disposed at an end of the valve pre-channel 105 opposite the channel interface 117 and separates the valve pre-channel 105 from the second discharge channel 120 located behind it. In contrast to the exemplary embodiment presented in the previous FIG. 1, the positions of the first discharge channel 110 and the valve pre-channel 105 are thus interchanged in this exemplary embodiment. As a result, the liquid flow is deflected by 90° degrees at the T-junction of the feed channel 110, valve pre-channel 105 and first discharge channel 115, as symbolized by the arrows shown in FIG. 3. Accordingly, the deflection of the liquid flow takes place in particular through an interaction of the liquid with the gas volume enclosed in the valve pre-channel 105. A larger section of the inserted liquid path 400 is marked in FIG. 4 with an arrow.

FIG. 5 shows a perspective side view of an exemplary embodiment of a microfluidic device 100 comprising a valve pre-channel 105. The device 100 shown in this case and the valve pre-channel 105 correspond to or are similar to the device and the valve pre-channel described in the preceding drawings. The perspective view in the drawing shown in this context illustrates the three-dimensional design of the microfluidic valves and the implementation of the fluidic and pneumatic microchannels on two different levels.

FIG. 6, FIG. 7, and FIG. 8 each show a top view of an exemplary embodiment of a microfluidic device 100 with a valve pre-channel 105 in the operating state. The device 100 shown in this case and the valve pre-channel 105 correspond to or are similar to the device and the valve pre-channel described in the preceding drawings. These three drawings in this case each correspond to the section of an implementation of the exemplary embodiment in the form of a polymer multilayer structure shown in the previous FIG. 4.

The various illustrations in FIG. 6, FIG. 7, and FIG. 8 show the course of a liquid 600 at three different times during a pumping process. For better contrast, a fluorescent dye is added to the liquid 600 to make it more visible or easier to image. The scaling bar 605 in FIG. 6 only corresponds to a length of 5 mm as an example. These three drawings represent a sequential process, with FIG. 6 corresponding to a time t1, FIG. 7 to a time t2 and FIG. 8 to a time t3, where t3>t2>t1. These three drawings show how the colored liquid 600 is pumped through the microfluidic network along the path shown in FIG. 4. This can be seen in the three drawings from the fact that in FIG. 6 initially only about one third of the path shown is wetted with liquid 600, in FIG. 7 about two thirds and in FIG. 8 finally the entire path is wetted with the colored liquid 600.

In this exemplary embodiment, the pumping process can be performed by means of a pump chamber of the device 100, into which liquid can be sucked in several times via an inlet valve and then expelled via an outlet valve, so that the path of the microfluidic network shown can be gradually wetted with the liquid 600. During this pumping process, the hydraulic pressure in the microfluidic system increases, particularly when the liquid is expelled. At the same time, the liquid moves along the switched path through the microfluidic system. Due to the pressure increase in the microfluidic system associated with the ejection process of the pump chamber, the present valve pre-channel 105 is used in an advantageous manner. This is illustrated in FIG. 6, FIG. 7, and FIG. 8 by means of enlarged sections from the three drawings, each of which shows the area of the device 100 marked in FIG. 6 by the rectangular box with a dashed line in an enlarged manner. This shows the valve 125, the valve pre-channel 105 and the channel interface 117 during the pumping process.

In FIG. 6, the valve pre-channel 105 is initially filled with a gas volume 130 which is, by way of example only, air, and the interface to the liquid 600 is disposed directly at the channel interface 117 adjacent to the valve pre-channel 105 which, by way of example only, is designed as a T-junction. FIG. 7 shows an illustration during a pumping surge. The pressure in the microfluidic system, i.e., in particular the pressure transmitted by the inflowing liquid 600, is increased compared to the situation shown in FIG. 6. Consequently, the liquid 600 is partially disposed in the valve pre-channel 105. The gas volume 130 present in the valve pre-channel 105 is thereby compressed, so a back pressure builds up. The counterpressure and the capacitive effect of the valve pre-channel 105 prevent the incoming liquid 600 from penetrating as far as the microfluidic valve 125 downstream of the valve pre-channel 105. Accordingly, a possible infiltration of the seal of the valve 125, which is merely an example of a membrane-based valve, is prevented.

After the pump surge shown in FIG. 7, the liquid 600 has moved further along the open path through the microfluidic network and the hydraulic pressure drops again. This state is shown in FIG. 8. The capacitive effect of the air-filled volume of the valve pre-channel 105 develops as a result of the drop in pressure exerted by the inflowing liquid 600. The previously existing counterpressure which was built up by the air in the valve pre-channel 105 is relaxed, so the liquid 600 that previously entered the valve pre-channel 105 is completely pressed out of it again. This is made possible in particular by the surface tension of the incoming liquid 600 and the associated capillary stabilization of the geometry of the phase interface. In this exemplary embodiment, the surface quality of the valve pre-channel 105 is also only hydrophobic by way of example, so that no liquid film caused by capillary forces remains in the valve pre-channel 105. In a particularly advantageous manner, the valve pre-channel 105 can in this case be used for a large number of pumping operations without undesirable infiltration of the seal of the valve 125 located behind it. In another exemplary embodiment, the valve pre-channel can also be slightly hydrophilic.

FIG. 9 shows a schematic top view of an exemplary embodiment of a microfluidic device 100. The device 100 shown in this case corresponds to or resembles the device described in the preceding drawings. In this exemplary embodiment, the device 100 comprises a microfluidic network 900 of various microfluidic channels, chambers and valves. In this exemplary embodiment, the network 900 comprises four functional units 901, 902, 903, 904, which are indicated by dashed lines. The individual functional units 901, 902, 903, 904 are merely exemplary when performing a microfluidic test sequence within the microfluidic network 900, in particular successively, i.e. one after the other, so different liquid solutions can be used in the individual steps of the microfluidic test sequence. By way of example only, the liquid can be pre-stored in a storage chamber 905 and can be introduced into the network by applying an overpressure to the storage chamber 905. To prevent unwanted mixing of different liquid solutions, the functional units 901, 902, 903, 904 can be separated from each other by microfluidic valves. A first functional unit 901 can, e.g., be separated from a second functional unit 902 by a valve 125 disposed on a valve pre-channel 105. In this exemplary embodiment, the further functional unit 902 comprises a further valve pre-channel 910, which is fluidically connected to a further feed channel 920 and a further first discharge channel 925, by way of example only, via a further channel interface 915. The further valve pre-channel 910 is in this case disposed between a further valve 930 and the further channel interface 915, whereby the further valve 930 in this exemplary embodiment is designed to separate the second functional unit 902 from a third functional unit 903. By way of example only, the further valve pre-channel 910 is designed in the same way as the valve pre-channel 105 in order to comprise a gas volume for shielding the further valve 930 from the liquid when the device 100 is in the ready-for-operation state. In this exemplary embodiment, all functional units 901, 902, 903, 904 of the device 100 are designed to be separable from one another. In this exemplary embodiment, the device 100 has, by way of example only, a lateral overall dimension of 186×78 mm². In another exemplary embodiment, the device can have overall dimensions of 75×25 mm² to 300×200 mm², preferably 100×50 mm² to 200×100 mm². In this exemplary embodiment, a pressure difference (positive pressure or negative pressure), which can be applied to generate the microfluidic flow by means of a pump chamber, e.g. by pressing out or sucking in, is in this case 700 mbar. In another exemplary embodiment, a pressure difference of 100 mbar to 2000 mbar, preferably 400 mbar to 1500 mbar, can be applied to the device. In this exemplary embodiment, the microfluidic device 100 is primarily made of polymers such as polycarbonate (PC) and thermoplastic polyurethane (TPU) using mass production methods such as injection molding, stamping and laser transmission welding. In other exemplary embodiments, the device can be manufactured using polystyrene (PS), styrene-acrylonitrile copolymer (SAN), polypropylene (PP), polyethylene (PE), cycloolefin copolymer (COP, COC), polymethyl methacrylate (PMMA), polydimethylsiloxane (PDMS), or a thermoplastic elastomer (TPE) such as styrene block copolymer (TPS).

FIG. 10 shows a flow chart of a method 1000 for operating a microfluidic device according to an exemplary embodiment. The device operable by means of this method corresponds to or is similar to the device described in the previous drawings. The method 1000 comprises a step 1005 of closing the valve of the device and a step 1010 of introducing a liquid into the feed channel, whereby the liquid is retained by the valve due to the volume of gas.

In another exemplary embodiment, the device can be designed without upstream valve channels. In this case, due to, e.g., manufacturing tolerances, incomplete displacement of the liquid can in this case occur in the valve area, leaving a liquid film in some areas of the microfluidic valve, which causes the seal to be infiltrated. In particular, if the liquid used has a high affinity to the surfaces, e.g. due to a similar polarity, seal infiltration can also be caused by wetting of the surfaces induced by capillary forces. In addition, if the hydraulic pressure exerted on the valve by the liquids exceeds the pneumatic pressure that presses the valve membrane onto the valve web, particularly for a short time, then the seal can be infiltrated and a leakage flow of liquid can occur in a device designed without valve pre-channels. If, for example, in an exemplary embodiment without valve pre-channels, the inertial forces, i.e., in particular the momentum transfer exerted on the valve membrane by the heavy mass of the liquids, exceed the counterforce exerted by the membrane on the liquids due to the pneumatic pressure applied to the membrane, especially for a short time, a seal infiltration can occur.

In the exemplary embodiment shown in the present context, sealing infiltration of microfluidic valves due to the valve pre-channels can be avoided, which has a beneficial effect on the performance and reliability of the microfluidic system.

FIG. 11 shows a flow chart of a method 1000 for operating a microfluidic device according to one exemplary embodiment. The method 1000 illustrated in this case corresponds to or is similar to the method described in the preceding FIG. 10, with the difference that the exemplary embodiment illustrated in this case comprises additional steps. In the present exemplary embodiment, during the closing step 1005, an overpressure is applied to a membrane of the valve to close the valve. In the following step 1010 of the introduction, an overpressure is, by way of example only, applied to a storage chamber storing the liquid in order to introduce the liquid into the feed channel. In this exemplary embodiment, the step 1010 of introducing the liquid is followed by a step 1100 of discharging the liquid via the first discharge channel. A gas volume is thereby present in the valve pre-channel, the capacitive effect of which prevents wetting of the microfluidic valve behind it. In this exemplary embodiment, the gas volume is compressed in step 1010 of introduction and expanded in step 1100 of discharging. In this exemplary embodiment, the steps 1010, 1100 of introducing and discharging are performed several times alternately, i.e. repeatedly, in order to convey a larger volume of liquid through the microfluidic network and/or to pump different liquid solutions through the microfluidic network. After the step 1100 of discharging, the method 1000 comprises, by way of example only, a step 1105 for opening the valve.

FIG. 12 shows schematic view of an exemplary embodiment of an analyzer 1200 for receiving a microfluidic device. The analyzer 1200 is designed, by way of example only, to receive a microfluidic device by means of an input port 1205 (as described in the preceding FIGS. 1 to 9) in order to perform analysis processes within the device. In this exemplary embodiment, the analyzer 1200 comprises a control device 1210 designed in this case to control the method steps described in the preceding FIGS. 10 and 11 with respect to the device.

1. A microfluidic device, comprising:
a feed channel configured to guide a liquid, wherein the feed channel leads into a channel interface;
a first discharge channel configured to additionally guide the liquid, wherein the first discharge channel is fluidically connected to the feed channel by way of the channel interface;
a valve pre-channel also configured to additionally guide the liquid, wherein the valve pre-channel is fluidically connected to the feed channel by way of the channel interface; and
a valve which is disposed between the valve pre-channel and a second discharge channel,
wherein when the device is in the ready-for-operation state, the valve pre-channel comprises a gas volume for shielding the valve from the liquid.

2. The microfluidic device according to claim 1, wherein a width of the valve pre-channel is less than or equal to 1.5 times the capillary length of a liquid located in the device.

3. The microfluidic device according to claim 1, wherein the valve is designed to isolate the valve pre-channel from the second discharge channel.

4. The microfluidic device according to claim 1, wherein the valve pre-channel is disposed substantially perpendicular to the feed channel and/or to the first discharge channel.

5. The microfluidic device according to claim 1, wherein the valve pre-channel is hydrophobic and the feed channel and/or the first discharge channel is hydrophilic.

6. The microfluidic device according to claim 1, wherein the device is designed as a pressure-based system.

7. The microfluidic device according to one of the preceding claim 1, wherein the valve is membrane-based.

8. The microfluidic device according to claim 1, wherein the valve comprises an actuation channel configured for the controlled deflection of a membrane into a valve recess.

9. The microfluidic device according to claim 1, wherein the valve pre-channel has a length of 0.5 mm to 10 mm and/or a cross-section of 100×100 μm² to 3×3 mm² and/or a volume of 100 nL to 5 μL.

10. The microfluidic device according to claim 1, further comprising a further valve pre-channel which is fluidically connected to a further feed channel and/or a further first discharge channel via a further channel interface,
wherein the further valve pre-channel is disposed between a further valve and the further channel interface, and
wherein the further valve pre-channel comprises a gas volume for shielding the further valve from the liquid when the device is in the ready-for-operation state.

11. A method for operating a microfluidic device according to claim 1, wherein the method comprises:
closing the valve; and
introducing a liquid into the feed channel, wherein the liquid is held by the valve due to the gas volume.

12. The method according to claim 11, wherein;
during the step of closing, a pressure is applied to a membrane of the valve in order to close the valve.

13. The method according to claim 11, wherein;
during the step of introduction, a pressure is applied to a storage chamber storing the liquid in order to introduce the liquid into the feed channel.

14. The method according to claim 11, further comprising:
discharging the liquid via the first discharge channel, wherein the gas volume is compressed during the step of introduction and expanded during the step of discharging.

15. The method according to claim 11, wherein an interface having a shape stabilized by capillary forces is formed in the valve pre-channel between the gas volume and the liquid which preferably causes a complete displacement of the liquid which penetrated into the valve pre-channel during the step of introduction from the valve pre-channel during the step of discharging.

16. The microfluidic device according to claim 1, wherein a maximum lateral expansion of a cross-sectional area of the valve pre-channel is less than the capillary length of a liquid located in the feed channel.
